(19) United States
(12) Patent Application Publication
(10) Pub. No.: US 2019/0315348 A1
(43) Pub. Date: Oct. 17, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Yoshitaka Mimura, Wako-shi (JP); Naoki Fukui, Wako-shi (JP)

(21) Appl. No.: 16/379,876

(22) Filed: Apr. 10, 2019

(30) Foreign Application Priority Data
Apr. 13, 2018 (JP) 2018-077865

(51) Int. Cl. B60W 30/09; G01C 21/36; B60W 30/095; B60W 30/12

(52) U.S. Cl. CPC B60W 30/09; G01C 21/3632; G01C 21/3647; G01C 21/3658; B60W 30/0956; B60R 2300/8086; B60R 2300/105; B60R 2300/205; B60R 2300/202; B60R 2300/207; B60R 2300/804; B60W 30/12

(57) ABSTRACT

A vehicle control device includes a display that displays an image, a recognizer that recognizes an object including another vehicle, a driving controller that generates a target trajectory of the own vehicle on the basis of a state of the recognized object and controls at least one of the speed or steering of the own vehicle on the basis of the target trajectory, and a display controller that causes the display to display a first image simulating the other vehicle, a second image simulating the target trajectory, and a third image simulating a road in which the own vehicle is present such that the first and second images are superimposed on the third image.

### CROSS-REFERENCE TO RELATED APPLICATION

This application is based upon and claims the benefit of priority from Japanese Patent Application No. 2018-077865, filed Apr. 13, 2018, the entire content of which is incorporated herein by reference.

### BACKGROUND

### Field of the Invention

The present invention relates to a vehicle control device, a vehicle control method, and a storage medium.

### Description of Related Art

In recent years, research on automatic control of the driving of a vehicle (hereinafter referred to as automated driving) has been conducted. On the other hand, a technology is known in which a front image-acquiring means that acquires a front image by capturing the area in front of a vehicle, a lane-specifying means that specifies a recommended lane in which the vehicle is to travel in the front image, and a display control means that generates a guidance line which has a rear end point at a rear end thereof indicating the current traveling position of the vehicle and a front end point at a front end thereof indicating a position in front of the rear end point in the recommended lane and causes a display to display the front image with the generated guidance line superimposed thereon are provided, wherein the display control means generates the guidance line such that the position of the front end point in the longitudinal direction of the front image is maintained constant while the front image with the generated guidance line superimposed thereon is continuously updated (for example, see Japanese Unexamined Patent Application, First Publication No. 2013-96913).

### SUMMARY

However, in the technology of the related art, since nearby vehicles are not taken into consideration when displaying an object of an image such as the guidance line, the occupant may misunderstand the relationship between the nearby vehicles and the object. As a result, the occupant may feel uneasy during automated driving.

Aspects of the present invention have been made in view of such circumstances and it is an object of the present invention to provide a vehicle control device, a vehicle control method, and a storage medium with which it is possible to perform automated driving that gives the occupant a greater sense of security.

A vehicle control device, a vehicle control method, and a storage medium according to the present invention adopt the following configurations.

(1) An aspect of the present invention provides a vehicle control device including a display configured to display an image, a recognizer configured to recognize an object present near an own vehicle (a subject vehicle), the object including another vehicle, a driving controller configured to generate a target trajectory of the own vehicle on the basis of a state of the object recognized by the recognizer and to control at least one of a speed or steering of the own vehicle on the basis of the generated target trajectory, and a display controller configured to cause the display to display a first image simulating the other vehicle recognized as the object by the recognizer, a second image simulating the target trajectory generated by the driving controller, and a third image simulating a road in which the own vehicle is present such that the first and second images are superimposed on the third image, wherein the second image is an image in which a first section that is on a near side of a reference vehicle, which is referred to when the target trajectory is generated, as viewed from the own vehicle among a plurality of sections into which the target trajectory is divided in a longitudinal direction is displayed with emphasis relative to a second section that is on a far side of the reference vehicle as viewed from the own vehicle.

(2) In the vehicle control device according to the above aspect (1), the second image is an image in which a portion corresponding to the first section is displayed and a portion corresponding to the second section is not displayed.

(3) In the vehicle control device according to the above aspect (1) or (2), the display controller is configured to change a display position of an end of the first section that is adjacent to the reference vehicle according to a position of the reference vehicle in an extension direction of a road.

(4) In the vehicle control device according to any one of the above aspects (1) to (3), the display controller is configured to set another vehicle present in a lane adjacent to an own lane in which the own vehicle is present as the reference vehicle if, on the basis of the other vehicle present in the adjacent lane, the driving controller generates a target trajectory causing the own vehicle to change lanes from the own lane into a space either in front of or behind the other vehicle present in the adjacent lane.

(5) Another aspect of the present invention provides a vehicle control method for an in-vehicle computer mounted in an own vehicle including a display configured to display an image, the method including the in-vehicle computer recognizing an object present near the own vehicle, the object including another vehicle, generating a target trajectory of the own vehicle on the basis of a state of the recognized object, controlling at least one of a speed or steering of the own vehicle on the basis of the generated target trajectory, and causing the display to display a first image simulating the other vehicle recognized as the object, a second image simulating the generated target trajectory, and a third image simulating a road in which the own vehicle is present such that the first and second images are superimposed on the third image, wherein the second image is an image in which a first section that is on a near side of a reference vehicle, which is referred to when the target trajectory is generated, as viewed from the own vehicle among a plurality of sections into which the target trajectory is divided in a longitudinal direction is displayed with emphasis relative to a second section that is on a far side of the reference vehicle as viewed from the own vehicle.

(6) Another aspect of the present invention provides a computer-readable non-transitory storage medium storing a program causing an in-vehicle computer mounted in an own vehicle including a display configured to display an image to execute a process of recognizing an object present near the own vehicle, the object including another vehicle, a process of generating a target trajectory of the own vehicle on the basis of a state of the recognized object, a process of controlling at least one of a speed or steering of the own vehicle on the basis of the generated target trajectory, a process of causing the display to display a first image simulating the other vehicle recognized as the object, a second image simulating the generated target trajectory, and a third image simulating a road in which the own vehicle is present such that the first and second images are superimposed on the third image, and a process of causing the display to display, as the second image, an image in which a first section that is on a near side of a reference vehicle, which is referred to when the target trajectory is generated, as viewed from the own vehicle among a plurality of sections into which the target trajectory is divided in a longitudinal direction is displayed with emphasis relative to a second section that is on a far side of the reference vehicle as viewed from the own vehicle.

According to any of the above aspects (1) to (6), it is possible to perform automated driving that gives the occupant a greater sense of security.

### BRIEF DESCRIPTION OF THE DRAWINGS

FIG. 1 is a configuration diagram of a vehicle system using a vehicle control device according to a first embodiment.

FIG. 2 is a diagram schematically showing the appearance of the interior of an own vehicle.

FIG. 3 is a functional configuration diagram of a first controller, a second controller, and a third controller.

FIG. 4 is a diagram illustrating a scenario in which the own vehicle is caused to change lanes.

FIG. 5 is a diagram illustrating a scenario in which the own vehicle is caused to change lanes.

FIG. 6 is a diagram illustrating a scenario in which the own vehicle is caused to change lanes.

FIG. 7 is a flowchart showing an example of the flow of a series of processes performed by an automated driving control device of the first embodiment.

FIG. 8 is a diagram showing an example of a screen displayed on a first display before lane-change;

FIG. 9 is an enlarged view of an image in the vicinity of a lock-on vehicle.

FIG. 10 is a diagram showing an example of a screen displayed next to the screen illustrated in FIG. 9.

FIG. 11 is a diagram showing an example of a screen displayed next to the screen illustrated in FIG. 10.

FIG. 12 is an enlarged view of an image in the vicinity of a lock-on vehicle.

FIG. 13 is a diagram showing an example of a screen displayed next to the screen illustrated in FIG. 11.

FIG. 14 is a diagram illustrating a method of extending a first section of a target trajectory.

FIG. 15 is a diagram illustrating a method of extending the first section of the target trajectory.

FIG. 16 is a diagram showing an example of a screen displayed next to the screen illustrated in FIG. 13.

FIG. 17 is a diagram showing an example of a screen displayed on the first display after lane-change;

FIG. 18 is a diagram showing an example of a screen displayed on a first display of a second embodiment.

FIG. 19 is a diagram showing another example of a screen displayed on the first display of the second embodiment.

FIG. 20 is a diagram showing an example of the relationship between the relative position of another vehicle with respect to the own vehicle and the display mode thereof.

FIG. 21 is a diagram showing an example of a scenario in which another vehicle is displayed translucently.

FIG. 22 is a diagram showing an example of a scenario in which other vehicles are not displayed translucently.

FIG. 23 is a diagram showing an example of a scenario in which other vehicles are present lateral to the own vehicle.

FIG. 24 is a diagram showing an example of a scenario in which other vehicles are present lateral to the own vehicle.

FIG. 25 is a diagram showing an example of the hardware configuration of an automated driving control device according to an embodiment.

### DESCRIPTION OF EMBODIMENTS

Hereinafter, embodiments of a vehicle control device, a vehicle control method, and a storage medium of the present invention will be described with reference to the drawings. In the embodiments, examples in which a display device displays recognition results of the surroundings of a vehicle when the vehicle performs automated driving (autonomous driving) will be described. Automated driving is driving of a vehicle by controlling one or both of the steering or speed of the vehicle regardless of driving operations of an occupant who is riding in the vehicle. Automated driving is a type of driving support to assist driving operations of the occupant such as that of an adaptive cruise control system (ACC) and a lane-keeping assistance system (LKAS).

### First Embodiment

### [Overall Configuration]

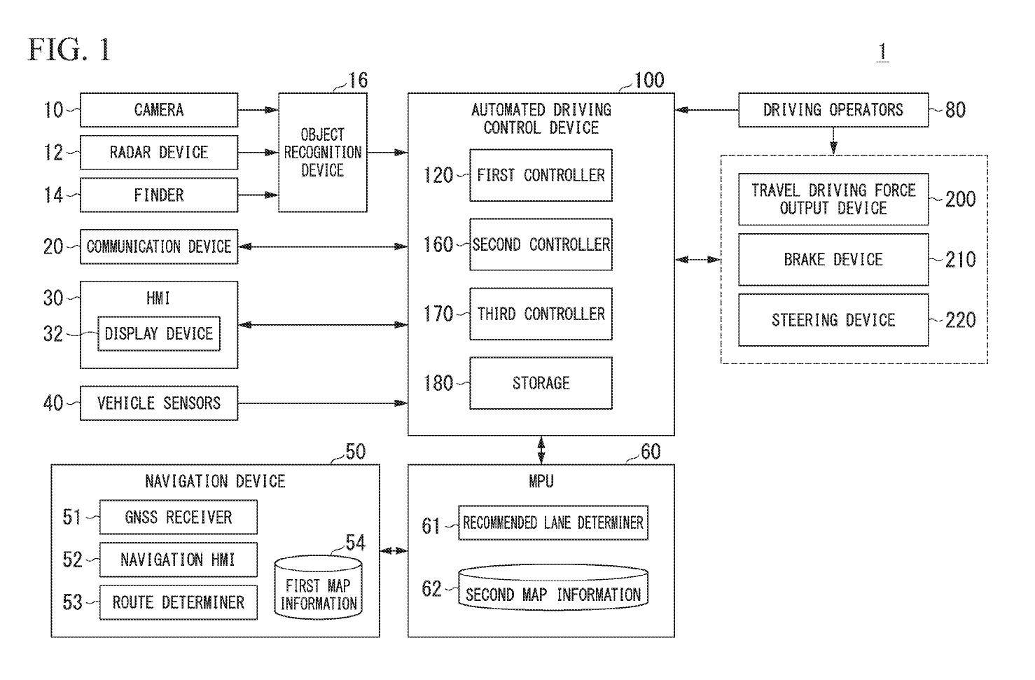

FIG. 1 is a configuration diagram of a vehicle system 1 using a vehicle control device according to a first embodiment. A vehicle in which the vehicle system 1 is mounted (hereinafter referred to as an own vehicle (a subject vehicle) M) is, for example, a vehicle such as a two-wheeled vehicle, a three-wheeled vehicle, or a four-wheeled vehicle, and a driving source thereof includes an internal combustion engine such as a diesel engine or a gasoline engine, an electric motor, or a combination thereof. The electric motor operates using electric power generated by a generator connected to the internal combustion engine or using discharge power of a secondary battery or a fuel cell.

The vehicle system 1 includes, for example, a camera 10, a radar device 12, a finder 14, an object recognition device 16, a communication device 20, a human machine interface (HMI) 30, vehicle sensors 40, a navigation device 50, a map positioning unit (MPU) 60, driving operators 80, an automated driving control device 100, a travel driving force output device 200, a brake device 210, and a steering device 220. These devices or apparatuses are connected to each other by a multiplex communication line or a serial communication line such as a controller area network (CAN) communication line, a wireless communication network, or the like. The components shown in FIG. 1 are merely examples and some of the components may be omitted or other components may be added.

The camera 10 is, for example, a digital camera using a solid-state imaging device such as a charge-coupled device (CCD) or complementary metal-oxide-semiconductor (CMOS) image sensor. The camera 10 is attached to the own vehicle M at an arbitrary location. For imaging the area in front of the vehicle, the camera 10 is attached to an upper portion of a front windshield, a rear surface of a rearview mirror, or the like. For example, the camera 10 repeats imaging of the surroundings of the own vehicle M at regular intervals. The camera 10 may also be a stereo camera.

The radar device 12 radiates radio waves such as millimeter waves around the own vehicle M and detects radio waves reflected by an object (reflected waves) to detect at least the position (distance and orientation) of the object. The radar device 12 is attached to the own vehicle M at an arbitrary location. The radar device 12 may detect the position and velocity of an object using a frequency-modulated continuous-wave (FM-CW) method.

The finder 14 is a light detection and ranging (LIDAR) finder. The finder 14 illuminates the surroundings of the own vehicle M with light and measures scattered light. The finder 14 detects the distance to a target on the basis of a period of time from when light is emitted to when light is received. The light radiated is, for example, pulsed laser light. The finder 14 is attached to the own vehicle M at an arbitrary location.

The object recognition device 16 performs a sensor fusion process on results of detection by some or all of the camera 10, the radar device 12, and the finder 14 to recognize the position, type, speed, or the like of the object. The object recognition device 16 outputs the recognition result to the automated driving control device 100. The object recognition device 16 may output detection results of the camera 10, the radar device 12 and the finder 14 to the automated driving control device 100 as they are. The object recognition device 16 may be omitted from the vehicle system 1.

For example, the communication device 20 communicates with other vehicles near the own vehicle M using a cellular network, a Wi-Fi network, Bluetooth (registered trademark), dedicated short-range communication (DSRC) or the like or communicates with various server devices via wireless base stations.

The HMI 30 presents various types of information to an occupant in the own vehicle M and receives an input operation from the occupant. The HMI 30 includes, for example, a display device 32, a speaker, a buzzer, a touch panel, switches, and keys. The display device 32 includes, for example, a first display 32A and a second display 32B. The display device 32 is an example of the “display.”

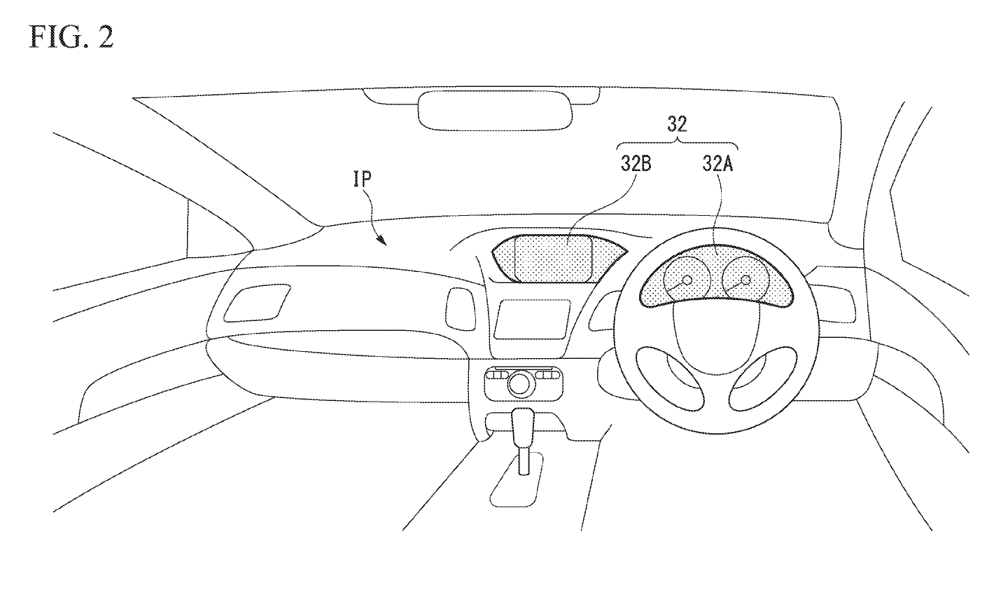

FIG. 2 is a diagram schematically showing the appearance of the interior of the own vehicle M. For example, the first display 32A is installed on an instrument panel IP in the vicinity of the front of the driver's seat (for example, the seat closest to the steering wheel) at a position where the occupant can view the first display 32A through the gap of the steering wheel or over the steering wheel. The first display 32A is, for example, a liquid crystal display (LCD) or organic electro-luminescence (EL) display device. Information necessary for travel of the own vehicle M during manual driving or automated driving is displayed as an image on the first display 32A. The information necessary for travel of the own vehicle M during manual driving is, for example, the speed of the own vehicle M, the rotation speed of the engine, the remaining amount of fuel, the radiator water temperature, the travel distance, and other information. The information necessary for travel of the own vehicle M during automated driving is, for example, information such as a future trajectory of the own vehicle M (a target trajectory which will be described later), whether or not lane-change is to be made, a lane to which lane-change is to be made, and lanes (lane lines) and other vehicles that have been recognized. The information necessary for travel of the own vehicle M during automated driving may also include some or all of the information necessary for travel of the own vehicle M during manual driving.

The second display 32B is installed, for example, in the vicinity of the center of the instrument panel IP. Like the first display 32A, the second display 32B is, for example, an LCD or organic EL display device. The second display 32B displays, for example, an image corresponding to a navigation process performed by the navigation device 50. The second display 32B may also display television shows, play DVDs, and display content such as downloaded movies.

The vehicle sensors 40 include a vehicle speed sensor that detects the speed of the own vehicle M, an acceleration sensor that detects the acceleration thereof, a yaw rate sensor that detects an angular speed thereof about the vertical axis, an orientation sensor that detects the orientation of the own vehicle M, or the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory.

The GNSS receiver 51 specifies the position of the own vehicle M on the basis of signals received from GNSS satellites. The position of the own vehicle M may also be specified or supplemented by an inertial navigation system (INS) using the output of the vehicle sensors 40.

The navigation HMI 52 includes a display device, a speaker, a touch panel, a key, or the like. The navigation HMI 52 may be partly or wholly shared with the HMI 30 described above.

For example, the route determiner 53 determines a route from the position of the own vehicle M specified by the GNSS receiver 51 (or an arbitrary input position) to a destination input by the occupant (hereinafter referred to as an on-map route) using the navigation HMI 52 by referring to the first map information 54. The first map information 54 is, for example, information representing shapes of roads by links indicating roads and nodes connected by the links. The first map information 54 may include curvatures of roads, point of interest (POI) information, or the like. The on-map route is output to the MPU 60.

The navigation device 50 may also perform route guidance using the navigation HMI 52 on the basis of the on-map route. The navigation device 50 may be realized, for example, by a function of a terminal device such as a smartphone or a tablet possessed by the occupant. The navigation device 50 may also transmit the current position and the destination to a navigation server via the communication device 20 and acquire a route equivalent to the on-map route from the navigation server.

The MPU 60 includes, for example, a recommended lane determiner 61 and holds second map information 62 in a storage device such as an HDD or a flash memory. The recommended lane determiner 61 divides the on-map route provided from the navigation device 50 into a plurality of blocks (for example, into blocks each 100 meters long in the direction in which the vehicle travels) and determines a recommended lane for each block by referring to the second map information 62. The recommended lane determiner 61 determines the number of the lane from the left in which to travel. When there is a branch point on the on-map route, the recommended lane determiner 61 determines a recommended lane such that the own vehicle M can travel on a reasonable route for proceeding to the branch destination.

The second map information 62 is map information with higher accuracy than the first map information 54. The second map information 62 includes, for example, information of the centers of lanes, information of the boundaries of lanes, or information of the types of lanes. The second map information 62 may also include road information, traffic regulation information, address information (addresses/postal codes), facility information, telephone number information, or the like. The second map information 62 may be updated as needed by the communication device 20 communicating with another device.

The driving operators 80 include, for example, an accelerator pedal, a brake pedal, a shift lever, a steering wheel, a different shaped steering member, a joystick, and other operators. Sensors for detecting the amounts of operation or the presence or absence of operation are attached to the driving operators 80. Results of the detection are output to the automated driving control device 100 or some or all of the travel driving force output device 200, the brake device 210, and the steering device 220.

The automated driving control device 100 includes, for example, a first controller 120, a second controller 160, a third controller 170, and a storage 180. Each of the first controller 120, the second controller 160, and the third controller 170 is realized, for example, by a processor such as a central processing unit (CPU) or a graphics-processing unit (GPU) executing a program (software). Some or all of these components may be realized by hardware (including circuitry) such as large-scale integration (LSI), an application-specific integrated circuit (ASIC), or a field-programmable gate array (FPGA) or may be realized by hardware and software in cooperation. The program may be stored in the storage 180 in the automated driving control device 100 in advance or may be stored in a detachable storage medium such as a DVD or a CD-ROM and then installed in the storage 180 by inserting the storage medium into a drive device.

The storage 180 is realized by an HDD, a flash memory, an electrically-erasable programmable read-only memory (EEPROM), a read-only memory (ROM), a random-access memory (RAM), or the like. The storage 180 stores, for example, a program that is read and executed by a processor.

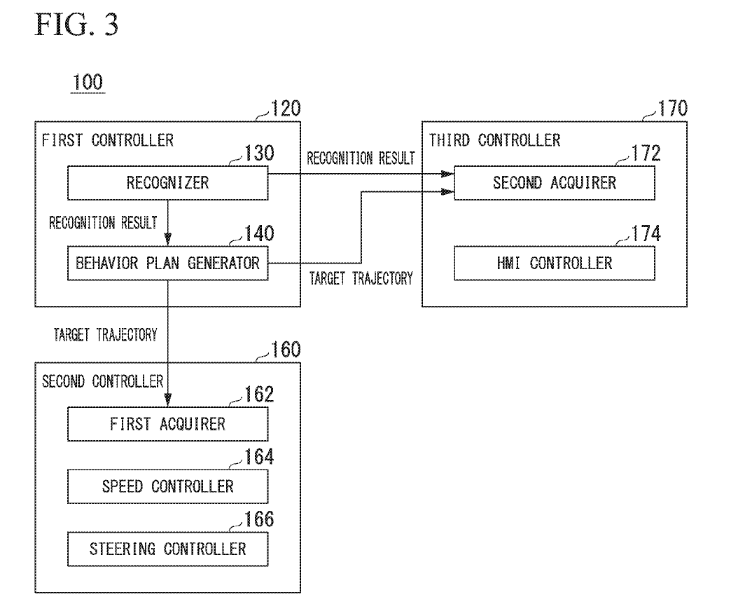

FIG. 3 is a functional configuration diagram of the first controller 120, the second controller 160, and the third controller 170. The first controller 120 includes, for example, a recognizer 130 and a behavior plan generator 140. For example, the first controller 120 realizes a function based on artificial intelligence (AI) and a function based on a previously given model in parallel. For example, the function of “recognizing an intersection” is realized by performing recognition of an intersection through deep learning or the like and recognition based on previously given conditions (presence of a signal, a road sign, or the like for which pattern matching is possible) in parallel and evaluating both comprehensively through scoring. This guarantees the reliability of automated driving.

The recognizer 130 recognizes objects present near the own vehicle M on the basis of information input from the camera 10, the radar device 12, and the finder 14 via the object recognition device 16. The objects recognized by the recognizer 130 include, for example, a bicycle, a motorcycle, a four-wheeled vehicle, a pedestrian, a road marking, a road sign, a lane line, a utility pole, a guardrail, and a fallen object. The recognizer 130 recognizes states of each object such as the position, speed and acceleration thereof. The position of the object is recognized, for example, as a position in a relative coordinate system whose origin is at a representative point on the own vehicle M (such as the center of gravity or the center of a drive shaft thereof) (that is, as a relative position with respect to the own vehicle M), and used for control. The position of the object may be represented by a representative point on the object such as the center of gravity or a corner thereof or may be represented by an expressed region. The “states” of the object may include an acceleration or jerk of the object or a “behavior state” thereof (for example, whether or not the object is changing or is going to change lanes).

The recognizer 130 recognizes, for example, an own lane in which the own vehicle M is traveling or a lane adjacent to the own lane. For example, the recognizer 130 recognizes the own lane or the adjacent lane, for example, by comparing a pattern of road lane lines (for example, an arrangement of solid and broken lines) obtained from the second map information 62 with a pattern of road lane lines near the own vehicle M recognized from an image captured by the camera 10.

The recognizer 130 may recognize the own lane or the adjacent lane by recognizing travel boundaries (road boundaries) including road lane lines, road shoulders, curbs, a median strip, guardrails, or the like, without being limited to road lane lines. This recognition may be performed taking into consideration a position of the own vehicle M acquired from the navigation device 50 or a result of processing by the INS. The recognizer 130 recognizes temporary stop lines, obstacles, red lights, toll gates, and other road phenomena.

When recognizing the own lane, the recognizer 130 recognizes the relative position or attitude of the own vehicle M with respect to the own lane. For example, the recognizer 130 may recognize both a deviation from the lane center of the reference point of the own vehicle M and an angle formed by the travel direction of the own vehicle M relative to an extension line of the lane center as the relative position and attitude of the own vehicle M with respect to the own lane. Alternatively, the recognizer 130 may recognize the position of the reference point of the own vehicle M with respect to one of the sides of the own lane (a road lane line or a road boundary) or the like as the relative position of the own vehicle M with respect to the own lane.

The behavior plan generator 140 includes, for example, an event determiner 142, and a target trajectory generator 144. The event determiner 142 determines an automated driving event in the route in which the recommended lane has been determined. The event is information defining the travel mode of the own vehicle M.

Events include, for example, a constant-speed travel event which is an event of causing the own vehicle M to travel in the same lane at a constant speed, a following travel event which is an event of causing the own vehicle M to follow another vehicle which is present within a predetermined distance (for example, within 100 meters) ahead of the own vehicle M and is closest to the own vehicle M (hereinafter referred to as a preceding vehicle mA), a lane-change event which is an event of causing the own vehicle M to change lanes from the own lane to an adjacent lane, a branching event which is an event of causing the own vehicle M to branch to a target lane at a branch point of a road, a merging event which is an event of causing the own vehicle M to merge into a main line at a merge point, and a takeover event which is an event of terminating automated driving and switching to manual driving. Here, “following” the preceding vehicle mA may indicate, for example, a travel mode which keeps the inter-vehicle distance (relative distance) between the own vehicle M and the preceding vehicle mA constant, and may also indicate a travel mode which causes the own vehicle M to travel along the center of the own lane in addition to keeping the inter-vehicle distance between the own vehicle M and the preceding vehicle mA constant. The events may also include, for example, an overtaking event which is an event of causing the own vehicle M to temporarily change lanes to an adjacent lane to overtake the preceding vehicle mA in the adjacent lane and then to change lanes to the original lane again or an event of causing the own vehicle M to approach one of the lane lines defining the own lane without lane-change to the adjacent lane to overtake the preceding vehicle mA in the own lane and then to return to the original position (for example, the center of the lane), and an avoidance event which is an event of causing the own vehicle M to perform at least one of braking and steering to avoid an obstacle present ahead of the own vehicle M.

For example, the event determiner 142 may change an event already determined for the current section to another event or determine a new event for the current section according to a surrounding situation that the recognizer 130 recognizes during travel of the own vehicle M.

The event determiner 142 may also change an event already determined for the current section to another event or determine a new event for the current section according to an operation performed on an in-vehicle device by the occupant. For example, when the occupant has operated a turn signal lever (a direction indicator), the event determiner 142 may change an event already determined for the current section to a lane-change event or determine a new lane-change event for the current section.

The target trajectory generator 144 generates a future target trajectory such that the own vehicle M travels basically in the recommended lane determined by the recommended lane determiner 61 and further travels automatically (without depending on the driver's operation) in a travel mode defined by the event to cope with the surrounding situation while the own vehicle M is traveling in the recommended lane. The target trajectory includes, for example, position elements that define the positions of the own vehicle M in the future and speed elements that define the speeds or the like of the own vehicle M in the future.

For example, the target trajectory generator 144 determines a plurality of points (trajectory points) which are to be sequentially reached by the own vehicle M as position elements of the target trajectory. The trajectory points are points to be reached by the own vehicle M at intervals of a predetermined travel distance (for example, at intervals of about several meters). The predetermined travel distance may be calculated, for example, by a road distance measured while traveling along the route.

The target trajectory generator 144 determines a target speed and a target acceleration for each predetermined sampling time (for example, every several tenths of a second) as speed elements of the target trajectory. The trajectory points may be positions to be reached by the own vehicle M at intervals of the predetermined sampling time. In this case, the target speed and the target acceleration are determined by the sampling time and the interval between the trajectory points. The target trajectory generator 144 outputs information indicating the generated target trajectory to the second controller 160.

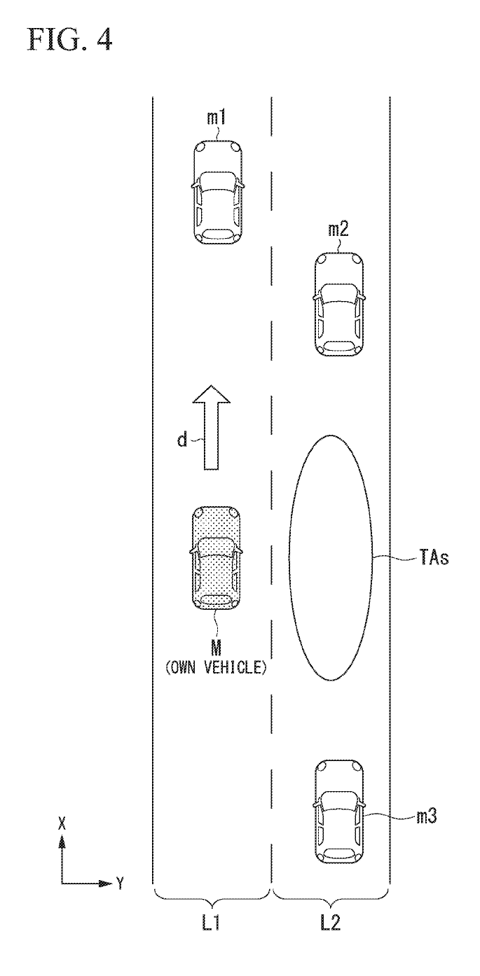

A scenario in which the own vehicle M travels in a section in which a lane-change event is planned, that is, a situation in which the own vehicle is caused to change lanes, will be described below as an example. FIGS. 4 to 6 are diagrams illustrating the scenario in which the own vehicle M is caused to change lanes. In the figures, L1 represents the own lane and L2 represents a lane adjacent to the own lane. X represents the extending direction of the road or the travel direction of the own vehicle M, and Y represents the lateral direction of the vehicle orthogonal to the X direction.

When the event in the current section is a lane-change event, the target trajectory generator 144 selects two other vehicles m2 and m3 from a plurality of other vehicles traveling in the adjacent lane L2 and sets a lane-change target position TAs between the two selected other vehicles. The lane-change target position TAs is a target position to which lane-change is to be made, and is a relative position between the own vehicle M and the other vehicles m2 and m3. In the shown example, the target trajectory generator 144 sets the lane-change target position TAs between the other vehicles m2 and m3 since the other vehicles m2 and m3 are traveling in the adjacent lane. When there is only one other vehicle in the adjacent lane L2, the target trajectory generator 144 may set the lane-change target position TAs at an arbitrary position in front of or behind the other vehicle. When there are no other vehicles in the adjacent lane L2, the target trajectory generator 144 may set the lane-change target position TAs at an arbitrary position in the adjacent lane L2. In the following description, another vehicle traveling immediately in front of the lane-change target position TAs in the adjacent lane (the other vehicle m2 in the shown example) will be referred to as a front reference vehicle mB and another vehicle traveling immediately behind the lane-change target position TAs in the adjacent lane (the other vehicle m3 in the shown example) will be referred to as a rear reference vehicle mC.

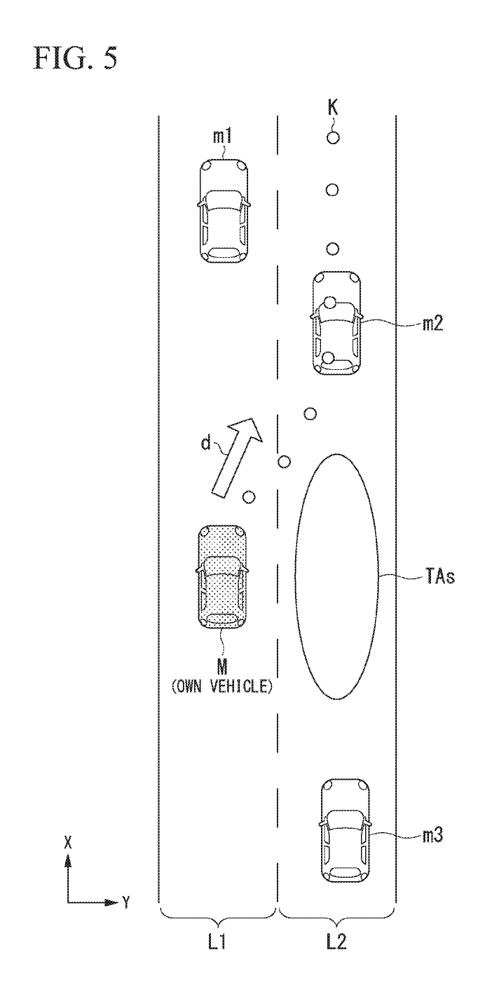

When the lane-change target position TAs has been set, the target trajectory generator 144 generates a plurality of candidate target trajectories causing the own vehicle M to change lanes. In the example of FIG. 5, assuming that each of the other vehicle m1 which is the preceding vehicle mA, the other vehicle m2 which is the front reference vehicle mB, and the other vehicle m3 which is the rear reference vehicle mC is traveling according to a predetermined speed model, the target trajectory generator 144 generates a plurality of candidate target trajectories on the basis of the speed model of these three vehicles and the speed of the own vehicle M such that the own vehicle M will be present at the lane-change target position TAs between the front reference vehicle mB and the rear reference vehicle mC at a future time without interfering with the preceding vehicle mA.

For example, the target trajectory generator 144 sequentially connects the current position of the own vehicle M, the position of the front reference vehicle mB at a future time or the center of the lane to which lane-change is to be made, and the end point of the lane-change smoothly using a polynomial curve such as a spline curve and arranges a predetermined number of trajectory points K at equal or unequal intervals on this curve. At this time, the target trajectory generator 144 generates a plurality of candidate target trajectories such that at least one of the trajectory points K is arranged within the lane-change target position TAs.

Then, the target trajectory generator 144 selects an optimum target trajectory from the plurality of generated candidate target trajectories. The optimum target trajectory is, for example, a target trajectory for which the yaw rate that is expected to occur when the own vehicle M is caused to travel on the basis of the target trajectory is less than a threshold value and the speed of the own vehicle M is within a predetermined speed range. The threshold value of the yaw rate is set, for example, to a yaw rate that does not cause an overload on the occupant (an acceleration in the lateral direction of the vehicle equal to or greater than a threshold value) when the lane-change is made. The predetermined speed range is set, for example, to a speed range of about 70 to 110 km/h.

When the target trajectory generator 144 has set the lane-change target position TAs and generated the target trajectory causing the own vehicle M to change lanes to the lane-change target position TAs, the target trajectory generator 144 determines whether or not it is possible to change lanes to the lane-change target position TAs (that is, into the space between the front reference vehicle mB and the rear reference vehicle mC).

For example, the target trajectory generator 144 sets a prohibited area RA in which the presence of other vehicles is prohibited in the adjacent lane L2 and determines that it is possible to change lanes if no part of another vehicle is present in the prohibited area RA and each of the time to collision (TTC) between the own vehicle M and the front reference vehicle mB and the TTC between the own vehicle M and the rear reference vehicle mC is greater than a threshold value. This determination condition is an example when the lane-change target position TAs is set to the side of the own vehicle M.

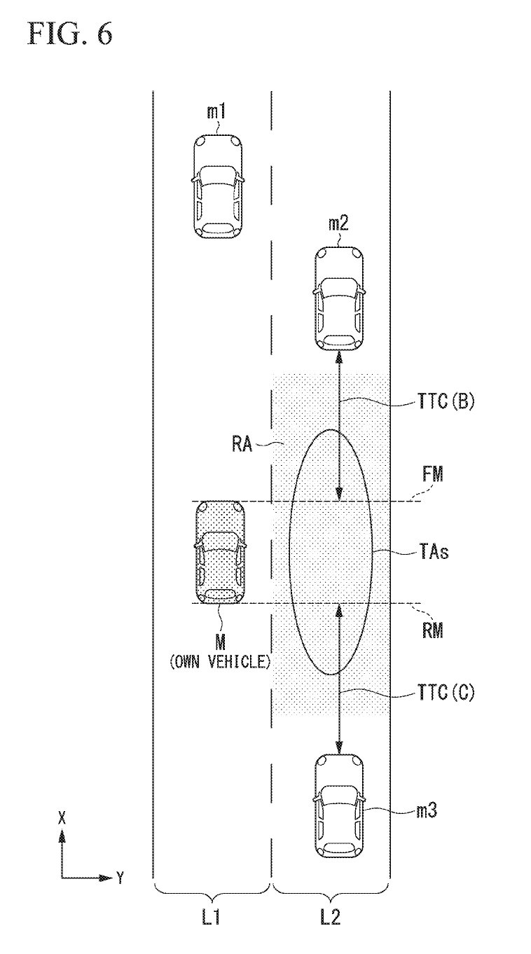

As illustrated in FIG. 6, for example, the target trajectory generator 144 projects the own vehicle M onto the lane L2 to which lane-change is to be made and sets a prohibited area RA having certain marginal distances forward and backward. The prohibited area RA is set as an area extending from one end to the other of the lane L2 in the lateral direction of the lane L2 (Y direction).

When there are no other vehicles in the prohibited area RA, the target trajectory generator 144 sets, for example, virtual extension lines FM and RM from the front and rear ends of the own vehicle M across the lane L2 to which lane-change is to be made. The target trajectory generator 144 calculates a time to collision TTC(B) between the extension line FM and the front reference vehicle mB and a time to collision TTC(C) between the extension line RM and the rear reference vehicle mC. The time to collision TTC(B) is derived by dividing the distance between the extension line FM and the front reference vehicle mB by the relative speed between the own vehicle M and the front reference vehicle mB (the other vehicle m2 in the shown example). The time to collision TTC(C) is derived by dividing the distance between the extension line RM and the rear reference vehicle mC by the relative speed of the own vehicle M and the rear reference vehicle mC (the other vehicle m3 in the shown example). The target trajectory generator 144 determines that it is possible to change lanes when the time to collision TTC(B) is greater than a threshold value Th(B) and the time to collision TTC(C) is greater than a threshold value Th(C). The threshold values Th(B) and Th(C) may be the same or different.

Upon determining that it is not possible to change lanes, the target trajectory generator 144 selects two new other vehicles from a plurality of other vehicles traveling in the adjacent lane L2 and resets a lane-change target position TAs between the newly selected two other vehicles. One of the newly selected two other vehicles may be the same as one of those previously selected.

The target trajectory generator 144 repeats setting of the lane-change target position TAs until it is determined that it is possible to change lanes. At this time, the target trajectory generator 144 may generate a target trajectory causing the own vehicle M to wait in the own lane L1 or may generate a target trajectory causing the own vehicle M to decelerate or accelerate to move to the side of the lane-change target position TAs in the own lane L1.

Upon determining that it is possible to change lanes, the target trajectory generator 144 outputs information indicating the generated target trajectory to the second controller 160.

The second controller 160 controls the travel driving force output device 200, the brake device 210, and the steering device 220 such that the own vehicle M passes along the target trajectory generated by the target trajectory generator 144 at scheduled times.

The second controller 160 includes, for example, a first acquirer 162, a speed controller 164, and a steering controller 166. A combination of the event determiner 142, the target trajectory generator 144, and the second controller 160 is an example of the “driving controller.”

The first acquirer 162 acquires information on the target trajectory (trajectory points) from the target trajectory generator 144 and stores it in a memory in the storage 180.

The speed controller 164 controls one or both of the travel driving force output device 200 and the brake device 210 on the basis of a speed element (for example, a target speed or a target acceleration) included in the target trajectory stored in the memory.

The steering controller 166 controls the steering device 220 according to a position element (for example, a curvature representing the degree of curvature of the target trajectory) included in the target trajectory stored in the memory. In the following description, control of either or both of the traveling driving force output and brake devices 200 and 210 or the steering device 220 will be referred to as “automated driving.”

The processing of the speed controller 164 and the steering controller 166 is realized, for example, by a combination of feedforward control and feedback control. As one example, the steering controller 166 performs the processing by combining feedforward control according to the curvature of the road ahead of the own vehicle M and feedback control based on deviation from the target trajectory.

The travel driving force output device 200 outputs a travel driving force (torque) required for the vehicle to travel to driving wheels. The travel driving force output device 200 includes, for example, a combination of an internal combustion engine, an electric motor, a transmission, and the like and a power electronic control unit (ECU) that controls them. The power ECU controls the above constituent elements according to information input from the second controller 160 or information input from the driving operators 80.

The brake device 210 includes, for example, a brake caliper, a cylinder that transmits hydraulic pressure to the brake caliper, an electric motor that generates hydraulic pressure in the cylinder, and a brake ECU. The brake ECU controls the electric motor according to information input from the second controller 160 or information input from the driving operators 80 such that a brake torque corresponding to a braking operation is output to each wheel. The brake device 210 may include, as a backup, a mechanism for transferring a hydraulic pressure generated by an operation of the brake pedal included in the driving operators 80 to the cylinder via a master cylinder. The brake device 210 is not limited to that configured as described above and may be an electronically controlled hydraulic brake device that controls an actuator according to information input from the second controller 160 and transmits the hydraulic pressure of the master cylinder to the cylinder.

The steering device 220 includes, for example, a steering ECU and an electric motor. The electric motor, for example, applies a force to a rack-and-pinion mechanism to change the direction of the steering wheel. The steering ECU drives the electric motor according to information input from the second controller 160 or information input from the driving operators 80 to change the direction of the steering wheel.

The third controller 170 includes, for example, a second acquirer 172 and an HMI controller 174. The HMI controller 174 is an example of the “display controller.”

The second acquirer 172 obtains information on results of recognition by the recognizer 130 and acquires information on the target trajectory generated by the target trajectory generator 144.

The HMI controller 174 controls the HMI 30 on the basis of the information acquired by the second acquirer 172 and causes the HMI 30 to output various types of information. For example, the HMI controller 174 causes the display device 32 of the HMI 30 (in particular, the first display 32A) to display a first layer image simulating other vehicles recognized by the recognizer 130 such as the preceding vehicle mA, the front reference vehicle mB, and the rear reference vehicle mC, a second layer image simulating the target trajectory generated by the target trajectory generator 144, and a third layer image simulating lanes recognized by the recognizer 130 (including the own lane and the adjacent lane) such that the first and second layer images are superimposed on the third layer image. The first layer image is an example of the “first image,” the second layer image is an example of the “second image,” and the third layer image is an example of the “third image.”

### [Process Flow]

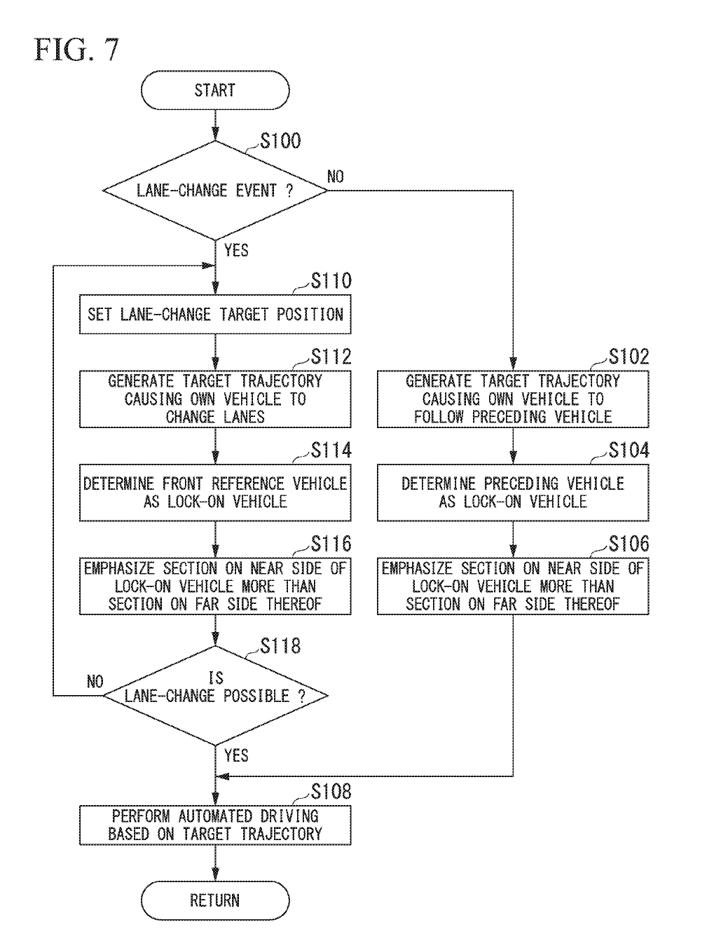

Hereinafter, a flow of a series of processes performed by the automated driving control device 100 of the first embodiment will be described with reference to a flowchart. FIG. 7 is a flowchart showing an example of the flow of the series of processes performed by the automated driving control device 100 of the first embodiment. For example, the process of this flowchart may be repeatedly performed at a predetermined cycle, for example, when the recognizer 130 has recognized a preceding vehicle mA.

First, the target trajectory generator 144 determines whether or not the current event is a lane-change event (step S100). If the current event is not a lane-change event, the target trajectory generator 144 generates a target trajectory causing the own vehicle M to follow the preceding vehicle mA (step S102).

Next, the HMI controller 174 determines the preceding vehicle mA which is the current following target as a lock-on vehicle (step S104). The lock-on vehicle is another vehicle that is referred to when the target trajectory is generated by the target trajectory generator 144 and that has influenced the target trajectory. The lock-on vehicle is displayed with emphasis (highlighted) in the first layer image. The lock-on vehicle is an example of the “reference vehicle.”

Next, the HMI controller 174 causes a first section A that is on the near side of the lock-on vehicle as viewed from the own vehicle M, among a plurality of sections into which the target trajectory is divided in the longitudinal direction, to be displayed with greater emphasis than a second section B that is on the far side of the lock-on vehicle as viewed from the own vehicle M in the second layer image (step S106).

Next, the second controller 160 controls at least either of the traveling driving force output and brake devices 200 and 210 or the steering device 220 on the basis of the target trajectory generated by the target trajectory generator 144 to perform automated driving (step S108).

On the other hand, if the current event is a lane-change event, the target trajectory generator 144 selects two other vehicles from a plurality of other vehicles traveling in the adjacent lane and sets a lane-change target position TAs between the two selected other vehicles (step S110).

Next, the target trajectory generator 144 generates a target trajectory causing the own vehicle M to change lanes to the adjacent lane in which the lane-change target position TAs has been set (step S112).

Next, the HMI controller 174 determines a front reference vehicle mB in front of the lane-change target position TAs, that is, a front reference vehicle mB which is to be a following target after lane-change, as a lock-on vehicle (step S114).

Next, in the second layer image, the HMI controller 174 causes a first section A that is on the near side of the lock-on vehicle as viewed from the own vehicle M, among a plurality of sections into which the target trajectory is divided in the longitudinal direction, to be displayed with greater emphasis than a second section B that is on the far side of the lock-on vehicle as viewed from the own vehicle M in the second layer image (step S116).

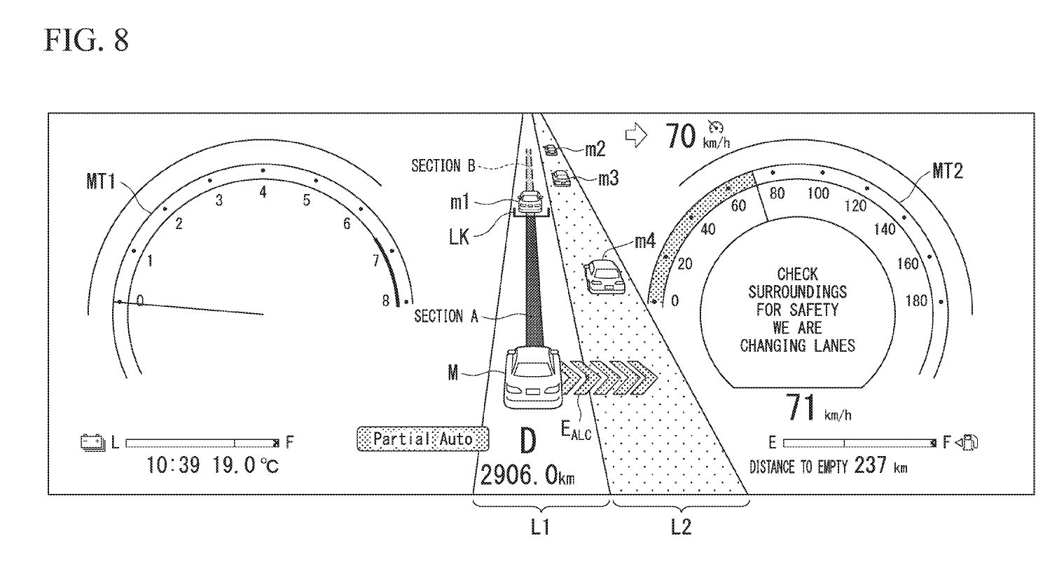

FIG. 8 is a diagram showing an example of a screen displayed on the first display 32A before lane-change. The example of FIG. 8 shows a screen displayed at the timing when the travel mode has been switched from following travel to lane-change. On this screen, a first layer image in which other vehicles m1 to m4 are displayed, a second layer image in which a target trajectory is displayed, and a third layer image in which an own lane L1 and an adjacent lane L2 are displayed are displayed as a single image by superimposing the first and second layer images on the third layer image. Together with the layer images, a tachometer MT1 indicating the rotation speed of the engine, a speed meter MT2 indicating the speed of the own vehicle M, characters or images informing the occupant in advance of lane-change, and the like may be displayed on the screen of the first display 32A.

At the timing when the travel mode has been switched from following travel to lane-change, a target trajectory for lane-change has not yet been generated. Therefore, the HMI controller 174 causes a target trajectory for following the other vehicle m1 which is a preceding vehicle mA to be displayed on the screen of the first display 32A and also causes an object image indicating that lane-change is to be made by automated driving (hereinafter referred to as a “lane-change expression image E_{ALC}”) to be displayed thereon as in the shown example. The object image is one element (a part) of each layer image.

When causing the lane-change expression image E_{ALC} to be displayed, the HMI controller 174 determines that the other vehicle m1 which is a following target is a lock-on vehicle and causes the lock-on vehicle to be displayed with a relatively brighter tone (lightness, the tone of a hue, or a light-dark level) than the other vehicles m2 to m4. Specifically, the HMI controller 174 may relatively emphasize the lock-on vehicle by lowering the lightness of vehicles other than the lock-on vehicle by about 50% as compared with the lock-on vehicle.

The HMI controller 174 causes an object image indicating that the own vehicle M is following the lock-on vehicle (hereinafter referred to as a “lock-on expression image LK”) to be displayed in the vicinity of the lock-on vehicle. In the example shown in FIG. 8, a U-shaped object image is displayed as the lock-on expression image LK at a rear end of the other vehicle m1 which is the lock-on vehicle. In this manner, the HMI controller 174 causes the lock-on vehicle to be displayed with a relatively brighter tone than the other vehicles and also causes the lock-on expression image LK to be displayed at the rear end of the lock-on vehicle, and therefore the lock-on vehicle is emphasized more than the other vehicles.

The HMI controller 174 causes the first section A that is on the near side of the lock-on vehicle as viewed from the own vehicle M to be displayed on the screen of the first display 32A with a brighter tone than the second section B that is on the far side of the lock-on vehicle as viewed from the own vehicle M to emphasize the first section A more than the second section B. For example, the HMI controller 174 may also cause the first section A to be displayed with a tone of a predetermined brightness and cause the second section B not to be displayed to emphasize the first section A more than the second section B.

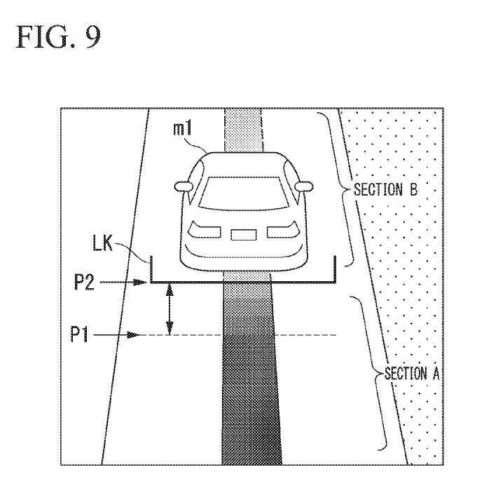

FIG. 9 is an enlarged view of an image in the vicinity of the lock-on vehicle. The HMI controller 174 sets a position P1 at a predetermined distance behind from the position P2 of the lock-on expression image LK as a reference and causes the first section A to be displayed with a tone changing from the reference position P1 to the position P2 as in the shown example. In this manner, the HMI controller 174 makes the display mode of the target trajectory different with reference to the other vehicle m1 which is the lock-on vehicle, between the near side and the far side of the other vehicle m1. For example, the HMI controller 174 may fade out the tip of the target trajectory (the farthest side of the second section B) such that it approaches the transparency (transmittance) of about 0%.

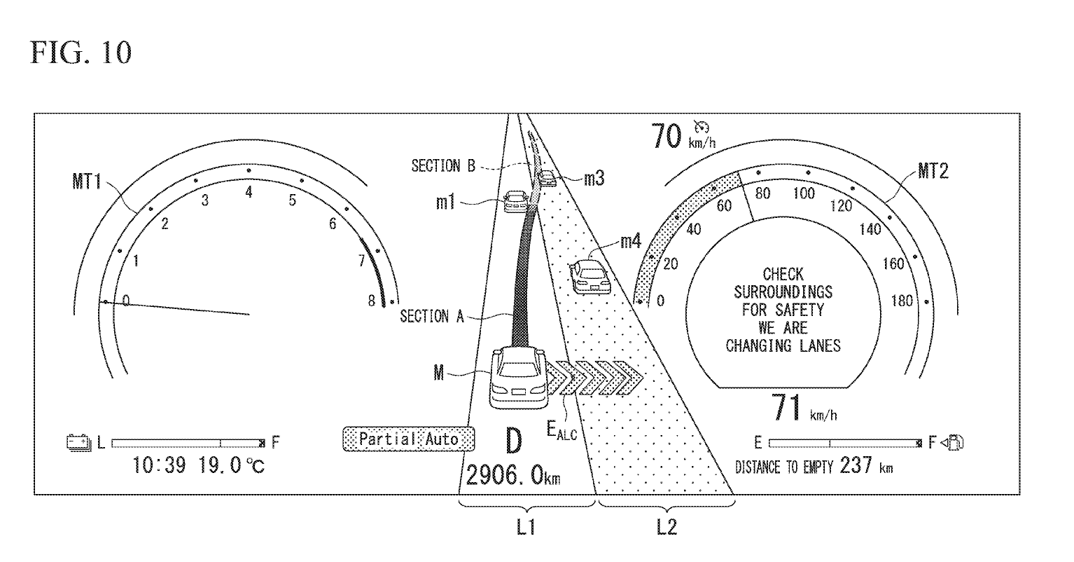

FIG. 10 is a diagram showing an example of a screen displayed next to the screen illustrated in FIG. 9. The screen of the shown example is displayed when the target trajectory generator 144 has set the lane-change target position TAs and generated a target trajectory causing the own vehicle M to change lanes to the adjacent lane L2. In response to the generation of the target trajectory for lane-change, the HMI controller 174 removes the lock-on expression image LK from the other vehicle m1.

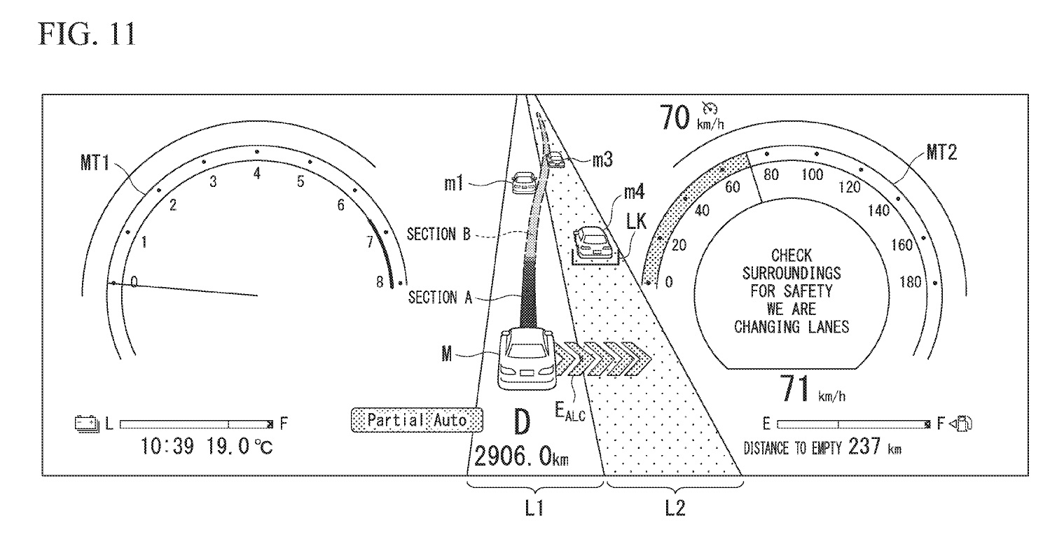

FIG. 11 is a diagram showing an example of a screen displayed next to the screen illustrated in FIG. 10. For example, it is assumed that the target trajectory generator 144 has selected another vehicle m4 and another vehicle m5 (not shown) behind the other vehicle m4, set a lane-change target position TAs between these two vehicles, and generated a target trajectory for lane-change. In this case, since the other vehicle m4, which is the front reference vehicle mB, becomes a following target vehicle after the lane-change, the HMI controller 174 determines the other vehicle m4 as a lock-on vehicle and causes a lock-on expression image LK to be displayed at the rear end of the other vehicle m4 as in the shown example. As a result, the other vehicle m4 is displayed as a lock-on vehicle newly with greater emphasis than other vehicles. When changing the lock-on vehicle, the HMI controller 174 changes the respective lengths of a section of the target trajectory which corresponds to the first section A and a section thereof which corresponds to the second section B. For example, the HMI controller 174 changes the first section A in the travel direction of the own vehicle M (X direction) from the section extending from the own vehicle M to the other vehicle m1 to the section extending from the own vehicle M to the other vehicle m4 and changes the second section B from the section after the other vehicle m1 to the section after the other vehicle m4.

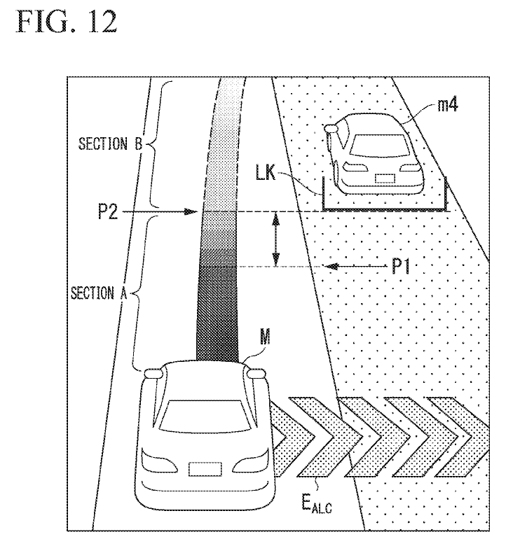

FIG. 12 is an enlarged view of an image in the vicinity of the lock-on vehicle. When the first section A on the near side of the other vehicle m4 which is a lock-on vehicle is present in the own lane L1, the HMI controller 174 sets a position P1 at a predetermined distance behind from the same position P2 as the lock-on expression image LK which is at the rear end of the other vehicle m4 as a reference in the travel direction of the own vehicle M (X direction) and causes the first section A to be displayed with a tone changing over a section from the position P1 to the position P2 as in the shown example.

Returning to FIG. 7, next, the target trajectory generator 144 determines whether or not it is possible to change lanes to the lane-change target position TAs (between the front reference vehicle mB and the rear reference vehicle mC) (step S118). Upon determining that it is not possible to change lanes to the lane-change target position TAs, the target trajectory generator 144 returns to the process of S110 and resets the lane-change target position TAs.

On the other hand, upon determining that it is possible to change lanes to the lane-change target position TAs, the target trajectory generator 144 outputs information indicating the generated target trajectory to the second controller 160. Upon receiving this, the second controller 160 controls the travel driving force output device 200, the brake device 210, and the steering device 220 on the basis of the target trajectory generated by the target trajectory generator 144 as a process of step S108 to cause the own vehicle M to change lanes to the lane-change target position TAs by automated driving.

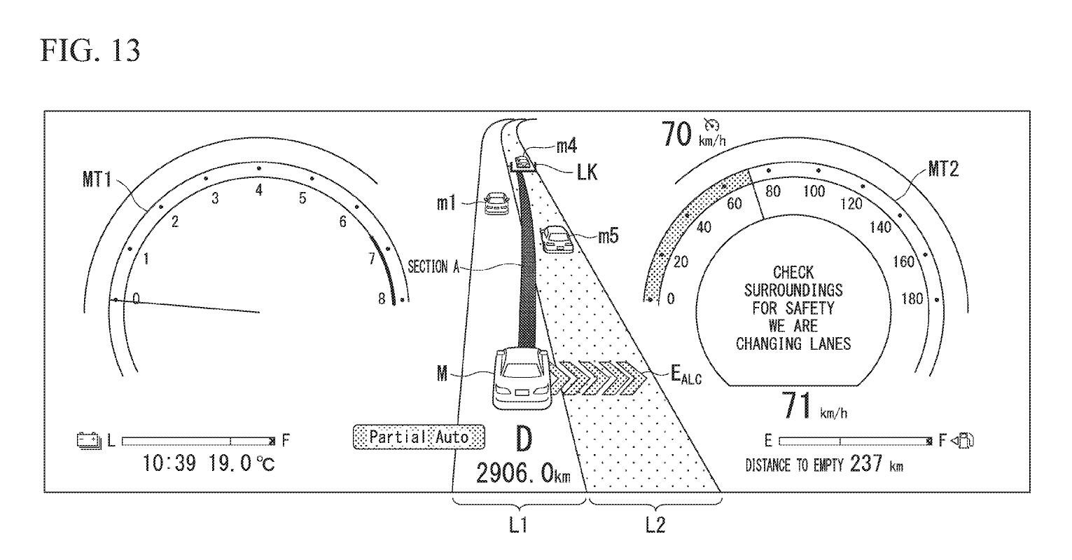

FIG. 13 is a diagram showing an example of a screen displayed next to the screen illustrated in FIG. 11. In the shown example, the target trajectory generator 144 determines that it is not possible to change lanes although the target trajectory generator 144 has set the lane-change target position TAs between the other vehicles m4 and m5, and the other vehicles m4 and m5 move further forward while the own vehicle M is waiting in the own lane L1 without changing lanes to the lane-change target position TAs. In such a case, until a new target trajectory is generated by the target trajectory generator 144, the HMI controller 174 changes the display position of the lock-on expression image LK according to the moving lock-on vehicle and also extends the first section A of the target trajectory.

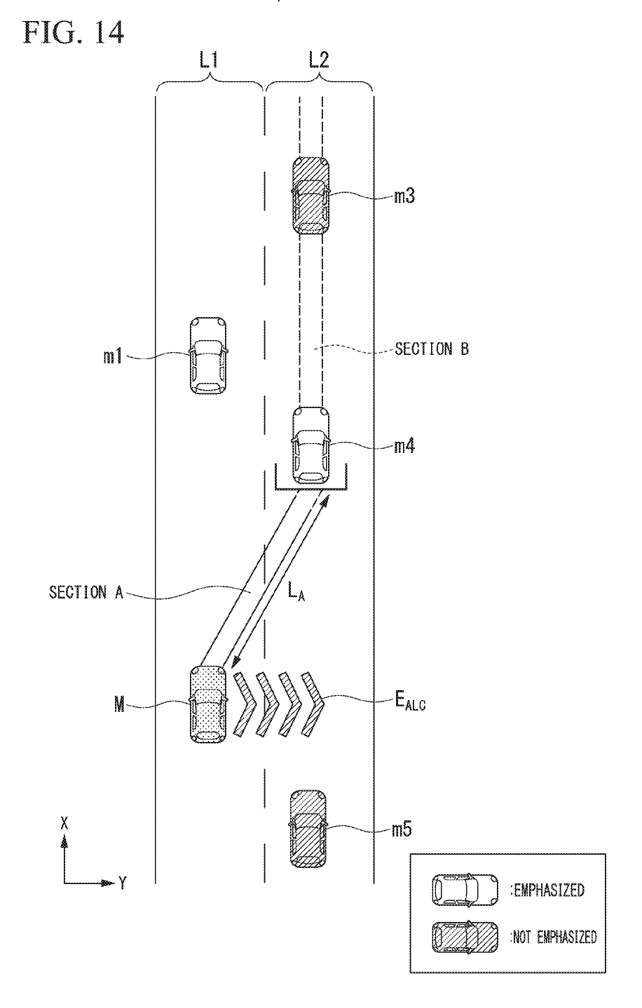

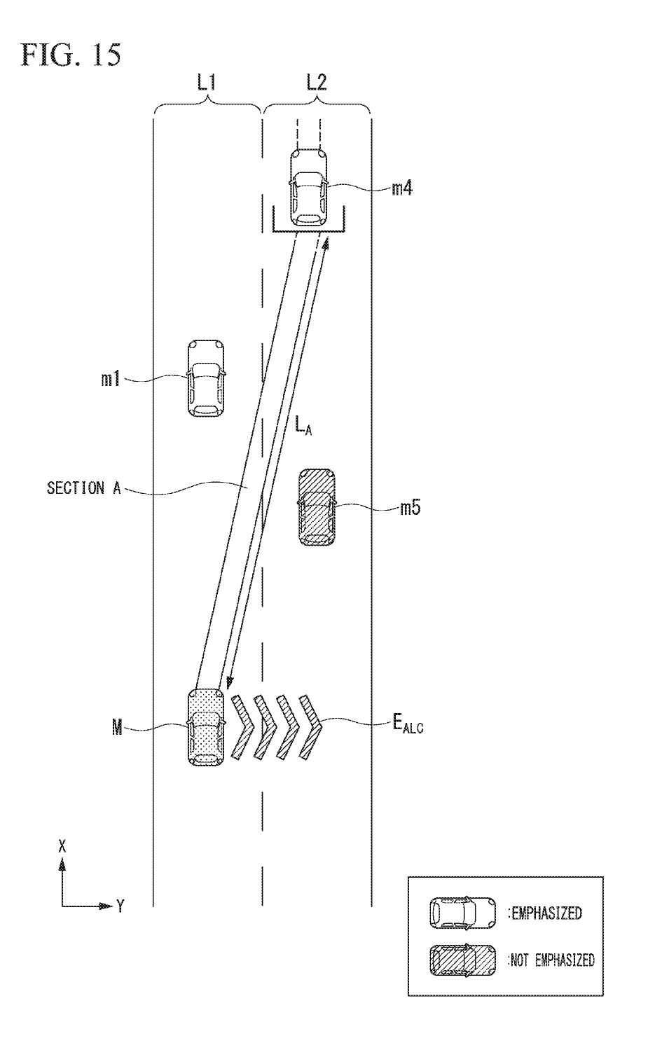

FIGS. 14 and 15 are diagrams illustrating a method of extending the first section A of the target trajectory. In the shown example, other vehicles m1, m3, m4, and m5 are recognized and, among these other vehicles, the other vehicles m1 and m4 are displayed with emphasis relative to the other vehicles m3 and m5. For example, when it is not possible to change lanes into the space between the other vehicle m4 that is a front reference vehicle mB and the other vehicle m5 that is a rear reference vehicle mC and the other vehicles m4 and m5 have moved away from the own vehicle M toward the far side in the screen, the HMI controller 174 continues to display the lock-on expression image LK behind the other vehicle m4 until a new target trajectory is generated by the target trajectory generator 144 and increases the length LA of the first section A by changing the display position of the end of the first section A according to the position of the lock-on vehicle in the X direction. The end of the first section A is one of the ends of the first section A which is adjacent to the lock-on vehicle rather than to the own vehicle M and is, for example, the position P2 described above. As a result, the first section A of the target trajectory is extended as illustrated in FIG. 15.

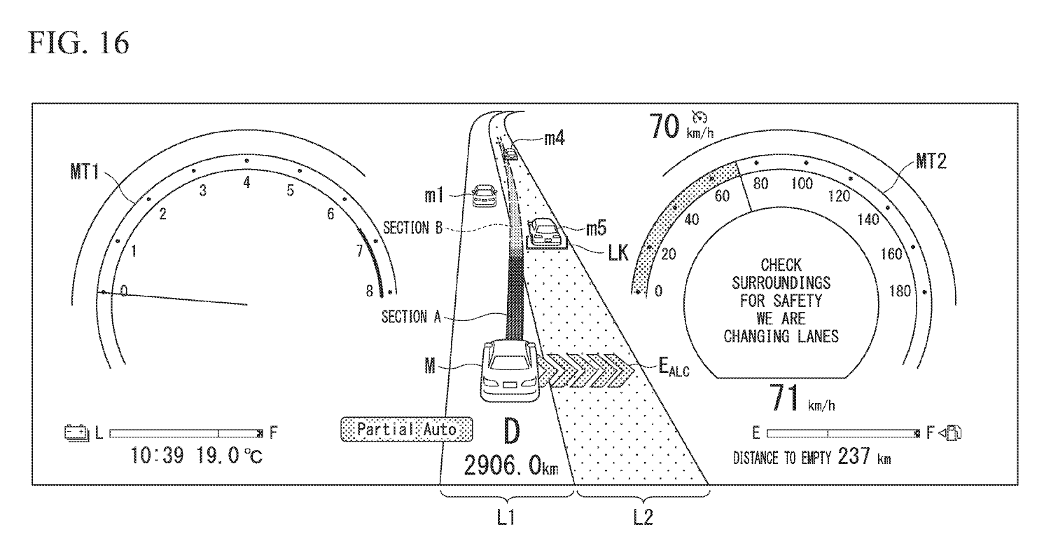

FIG. 16 is a diagram showing an example of a screen displayed next to the screen illustrated in FIG. 13. In the shown example, the target trajectory generator 144 newly sets a lane-change target position TAs behind the other vehicle m5 and generates a new target trajectory. In such a case, the HMI controller 174 newly determines the other vehicle m5 as a lock-on vehicle and causes a lock-on expression image LK to be displayed at the rear end of the other vehicle m5. As a result, the other vehicle m5 is emphasized more than the other vehicles.

Upon changing the lock-on vehicle from the other vehicle m4 to m5, the HMI controller 174 changes the first section A in the travel direction of the own vehicle M (X direction) from the section extending from the own vehicle M to the other vehicle m4 to the section extending from the own vehicle M to the other vehicle m5 and changes the second section B from the section after the other vehicle m4 to the section after the other vehicle m5 as in the shown example. In this manner, when the lane-change target position TAs is successively changed until lane-change is made, the first section A that is displayed with emphasis is changed while changing the lock-on vehicle every time the lane-change target position TAs is changed. Thus, it is possible to allow the occupant who is viewing the display device 32 to see which other vehicle the vehicle system 1 is currently referring to while trying to change lanes. Therefore, it is possible to prevent the occupant from misidentifying which vehicle to follow after the lane-change, and the behavior of the own vehicle M expected by the occupant can be made identical or close to the actual behavior of the own vehicle M by automated driving. As a result, it is possible to give the occupant a sense of security.

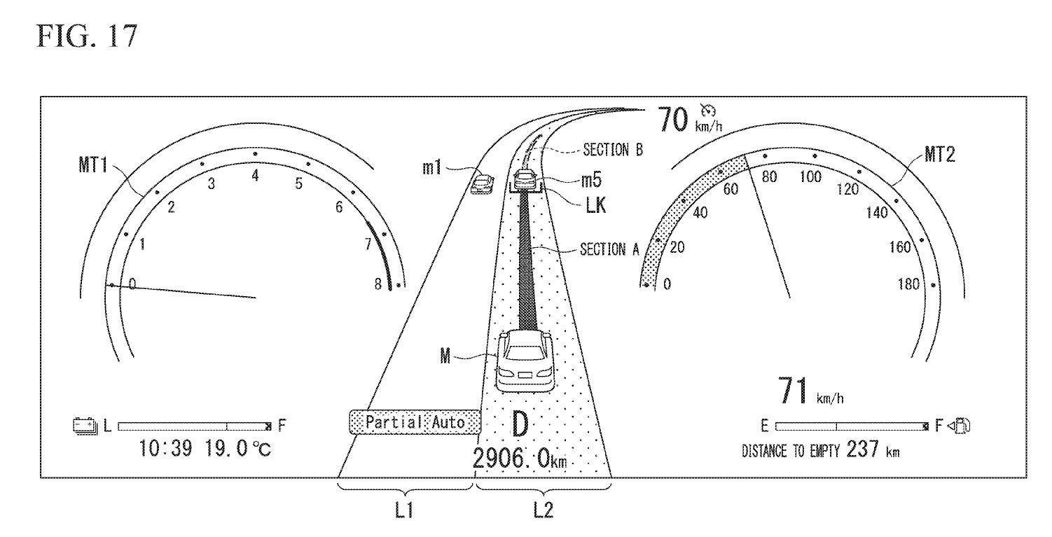

FIG. 17 is a diagram showing an example of a screen displayed on the first display 32A after lane-change. When the own vehicle M has changed lanes into the space behind the other vehicle m5, the event determiner 142 plans a following travel event with the other vehicle m5 as a following target and the target trajectory generator 144 generates a target trajectory with the other vehicle m5 as a following target as in the shown example. Upon receiving this, the HMI controller 174 continuously displays the lock-on expression image LK at the rear end of the other vehicle m5 to emphasize the other vehicle m5 more than the other vehicles.

According to the first embodiment described above, the display device 32 configured to display an image, the recognizer 130 configured to recognize objects present near the own vehicle M, the target trajectory generator 144 configured to generate a target trajectory of the own vehicle M on the basis of objects including one or more other vehicles recognized by the recognizer 130, the second controller 160 configured to control at least one of the speed or steering of the own vehicle M on the basis of the target trajectory generated by the target trajectory generator 144, and the HMI controller 174 configured to cause the display device 32 to display a first layer image simulating other vehicles recognized as objects by the recognizer 130, a second layer image simulating the target trajectory generated by the target trajectory generator 144, and a third layer image simulating a road in which the own vehicle M is present such that the first and second layer images are superimposed on the third layer image are provided, wherein the HMI controller 174 causes the second layer image, in which a first section A that is on the near side of the lock-on vehicle as viewed from the own vehicle M among a plurality of sections into which the target trajectory is divided in the longitudinal direction is displayed with emphasis relative to a second section B that is on the far side of the lock-on vehicle as viewed from the own vehicle M, to be superimposed on the third layer image. Thus, it is possible to allow the occupant who is viewing the display device 32 to see which other vehicle the vehicle system 1 is currently paying attention to while trying to change lanes. As a result, it is possible to perform automated driving which gives the occupant a greater sense of security.

### Second Embodiment

A second embodiment will now be described. The first embodiment wherein other vehicles ahead of the own vehicle M such as the preceding vehicle mA and the front reference vehicle mB are displayed with emphasis has been described above. On the other hand, the second embodiment is different from the first embodiment described above in that other vehicles behind the own vehicle M such as the rear reference vehicle mC are also displayed with emphasis. Hereinafter, differences from the first embodiment will be mainly described and descriptions of functions and the like in common with the first embodiment will be omitted.

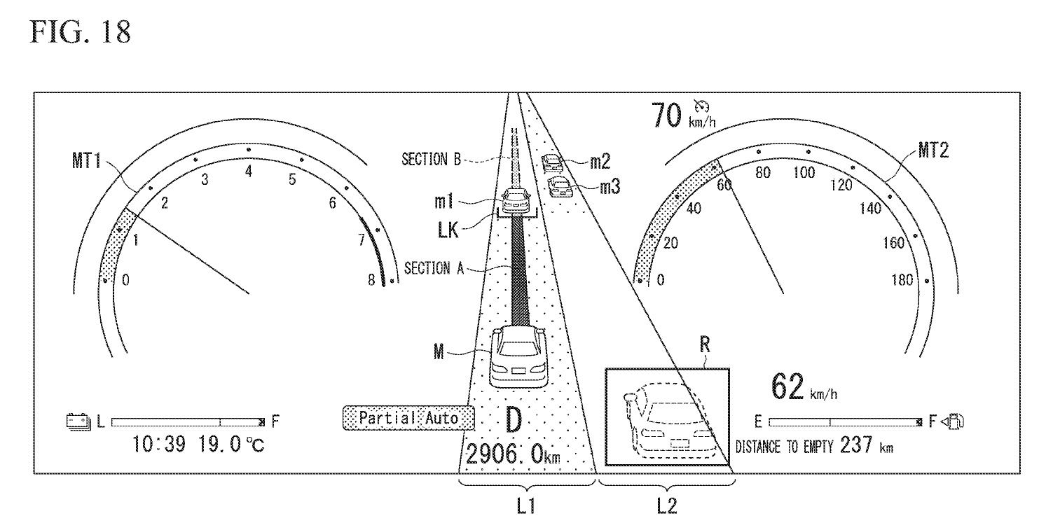

FIG. 18 is a diagram showing an example of a screen displayed on the first display 32A of the second embodiment. In the figure, R represents an area in which another vehicle behind the own vehicle M is displayed. In the shown example, a target trajectory causing the own vehicle M to follow another vehicle m1 which is a preceding vehicle mA is generated. In such a case, the other vehicle behind the own vehicle M in the adjacent lane L2 does not disturb the travel of the own vehicle M. In other words, because the other vehicle is not referred to by the target trajectory generator 144 when generating the target trajectory, the HMI controller 174 causes the other vehicle behind in the region R to be displayed translucently in the second embodiment as in the example of FIG. 18. For example, the HMI controller 174 causes the other vehicle behind the rear reference vehicle mC to be displayed with a transparency of about 20% of the transparency of the other vehicles (such as the lock-on vehicle and the own vehicle M). Thereby, the HMI controller 174 can notify the occupant that there is another vehicle approaching from behind the own vehicle M although it does not directly influence the generation of the target trajectory unlike the lock-on vehicle. As a result, it is possible to draw attention to the occupant to monitor the surroundings including the rear side of the own vehicle M.

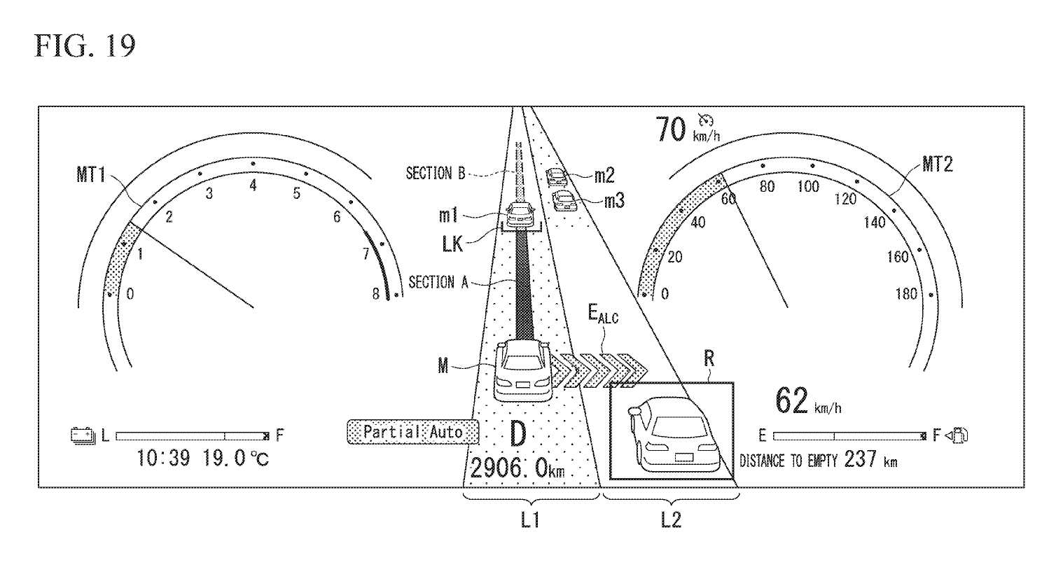

FIG. 19 is a diagram showing another example of a screen displayed on the first display 32A of the second embodiment. In the shown example, the travel mode has been switched from following travel to lane-change, and a lane-change expression image E_{ALC} is displayed. In such a case, another vehicle behind the own vehicle M in the adjacent lane L2 may interfere with the travel of the own vehicle M upon lane-change. Therefore, the HMI controller 174 in the second embodiment causes the other vehicle behind in the region R to be displayed with emphasis, similar to the lock-on vehicle or the like, as in the example of FIG. 19.

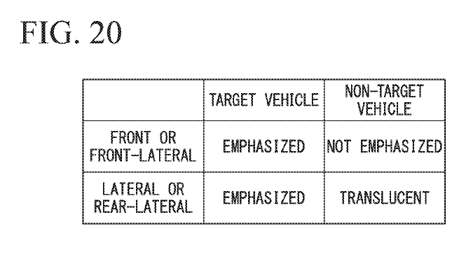

FIG. 20 is a diagram showing an example of the relationship between the relative position of another vehicle with respect to the own vehicle M and the display mode thereof. For example, when another vehicle is present ahead of or ahead of and lateral to the own vehicle M, the HMI controller 174 causes the other vehicle to be displayed with emphasis if it is a target vehicle that may interfere with the target trajectory and to be displayed without emphasis if it is not a target vehicle that may interfere with the target trajectory. Target vehicles that may interfere with the target trajectory are the preceding vehicle mA and the front reference vehicle mB that are candidates for the lock-on vehicle described above, and these are vehicles that are referred to by the target trajectory generator 144 when generating the target trajectory. Displaying without emphasis may be, for example, reducing the lightness by about 50% as described above. When another vehicle is present behind the own vehicle M, the HMI controller 174 causes the other vehicle to be displayed with emphasis if it is a target vehicle that may interfere with the target trajectory and to be displayed translucently without emphasis if it is not a target vehicle that may interfere with the target trajectory.

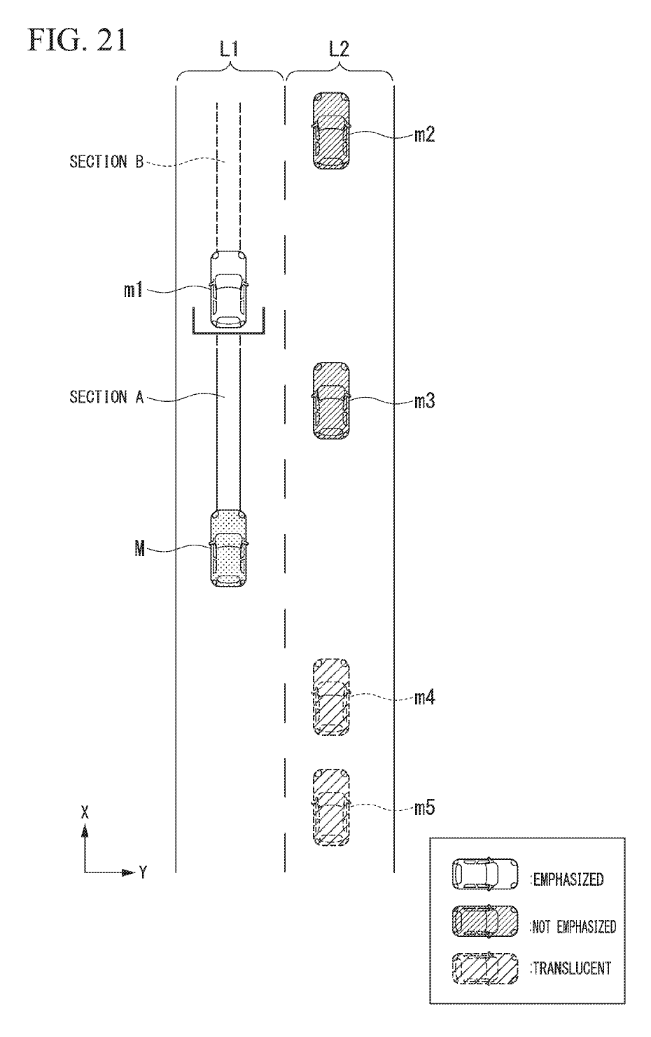

FIG. 21 is a diagram showing an example of a scenario in which another vehicle is displayed translucently. In the example of FIG. 21, another vehicle m1 is present ahead of the own vehicle M in the own lane L1, other vehicles m2 and m3 are present ahead of the own vehicle M in the adjacent lane L2, and other vehicles m4 and m5 are present behind the own vehicle M in the adjacent lane L2. In such a case, when the target trajectory generator 144 has generated a target trajectory with the other vehicle m1 as a following target, the HMI controller 174 determines the other vehicle m1 as a lock-on vehicle. Then, the HMI controller 174 causes the display device 32 to display the other vehicle m1 with emphasis, to display the other vehicles m2 and m3 without emphasis, and to display the other vehicles m4 and m5 translucently.

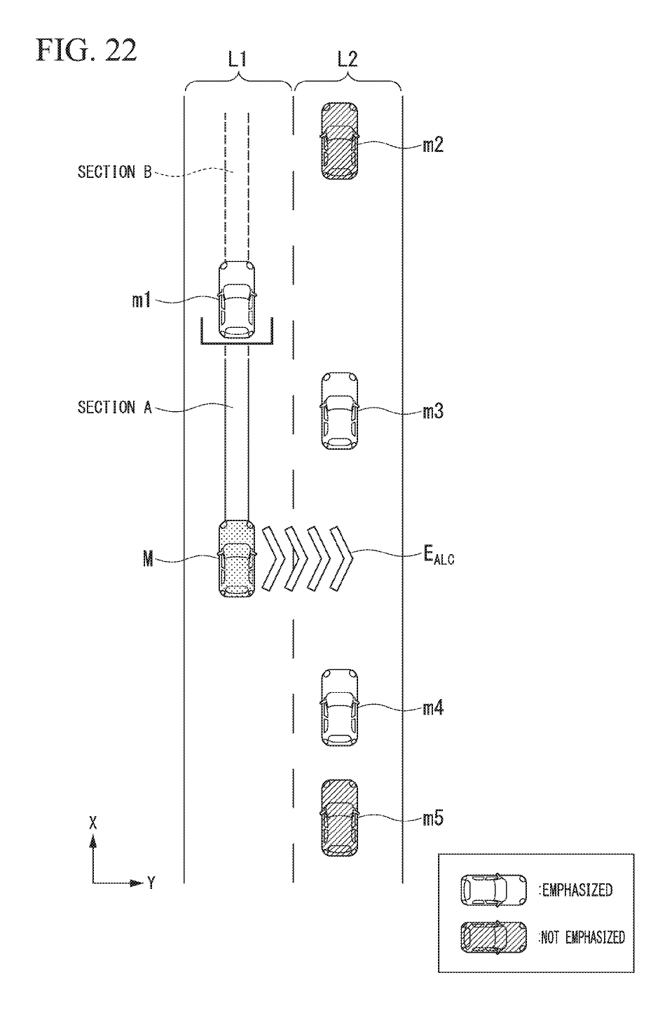

FIG. 22 is a diagram showing an example of a scenario in which other vehicles are not displayed translucently. In the example of FIG. 22, similar to the example of FIG. 21, another vehicle m1 is present ahead of the own vehicle M in the own lane L1, other vehicles m2 and m3 are present ahead of the own vehicle M in the adjacent lane L2, and other vehicles m4 and m5 are present behind the own vehicle M in the adjacent lane L2. In the example of FIG. 22, a lane-change event is planned, and as a result, a lane-change expression image E_{ALC} is displayed on the screen of the display device 32. In such a case, since the other vehicles m3 and m4 are target vehicles that may interfere with the target trajectory, the HMI controller 174 causes the display device 32 to display the other vehicles m1, m3 and m4 with emphasis and to display the other vehicles m2 and m5 without emphasis.

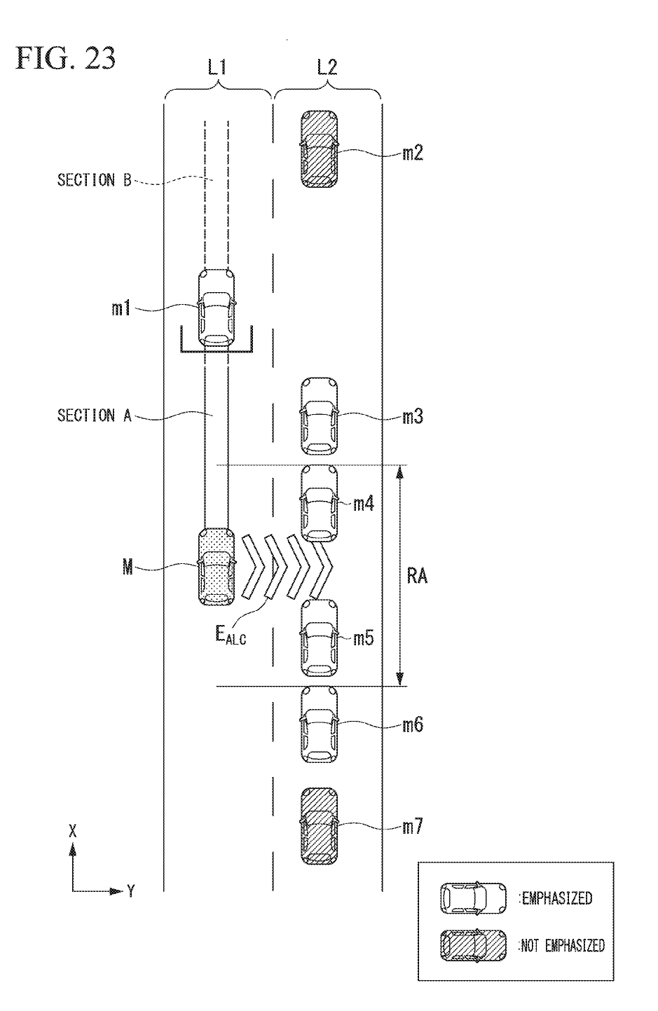

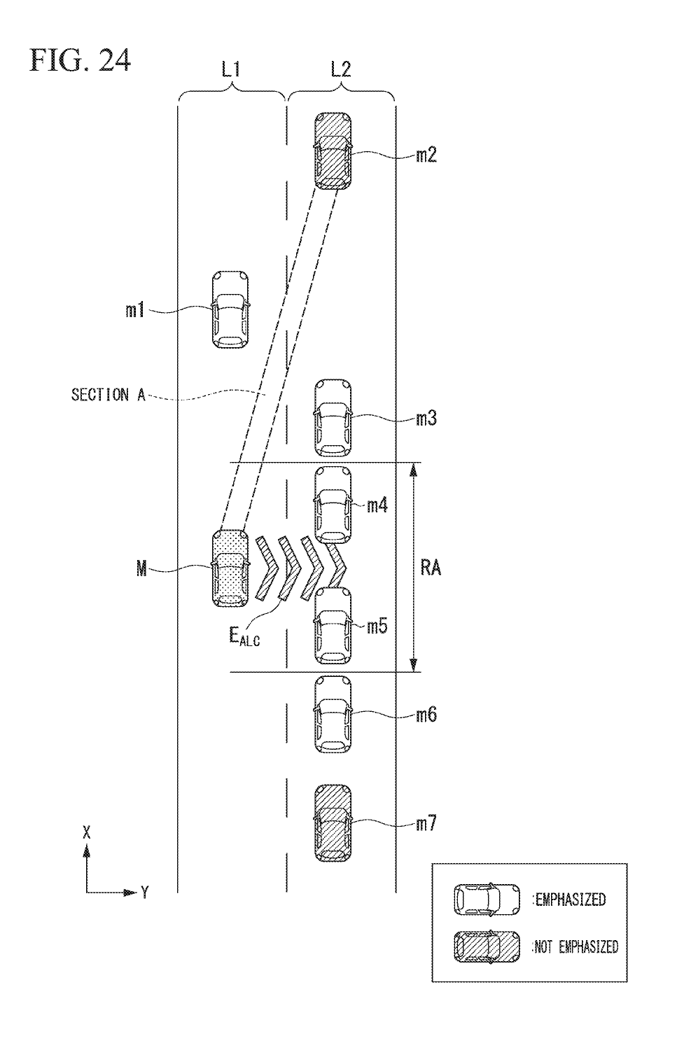

FIGS. 23 and 24 are diagrams showing examples of scenarios in which other vehicles are present lateral to the own vehicle M. In the shown examples, another vehicle m1 is present ahead of the own vehicle M in the own lane L1, other vehicles m2 and m3 are present ahead of the own vehicle M in the adjacent lane L2, other vehicles m4 and m5 are present lateral to the own vehicle M where a prohibited area RA is set, and other vehicles m6 and m7 are present behind the own vehicle M in the adjacent lane L2.

For example, if another vehicle is present in the prohibited area RA set in the adjacent lane L2 when the target trajectory generator 144 generates a target trajectory, the HMI controller 174 causes the display device 32 to display the other vehicle present in the prohibited area RA with emphasis. In the scenarios illustrated in FIGS. 23 and 24, the other vehicles m4 and m5 are present in the prohibited area RA and therefore the HMI controller 174 causes the display device 32 to display the other vehicle m1 which is a preceding vehicle mA, the other vehicles m3 and m6 which are closest to the prohibited area RA outside the prohibited area RA, and the other vehicles m4 and m5 in the prohibited area RA with emphasis and to display vehicles other than those without emphasis.

In the scenario illustrated in FIG. 23, a target trajectory for following travel with the other vehicle m1 as a following target is generated and therefore the HMI controller 174 causes the display device 32 to display a first section A that is on the near side of the other vehicle m1 with emphasis and to display a second section B that is on the far side of the other vehicle m1 without emphasis. In the scenario illustrated in FIG. 24, a target trajectory for lane-change with the other vehicle m2 being a following target after lane-change is generated. In such a case, lane-change is not performed since the other vehicles m4 and m5 are present in the prohibited area RA. Thus, the HMI controller 174 causes the display device 32 to display the entirety of the target trajectory without emphasis.

According to the second embodiment described above, when the own vehicle M is caused to change lanes, other vehicles behind the own vehicle M such as the rear reference vehicle mC are also displayed with emphasis. Therefore, it is possible to perform automated driving which gives the occupant a further sense of security, compared to the first embodiment.

### [Hardware Configuration]

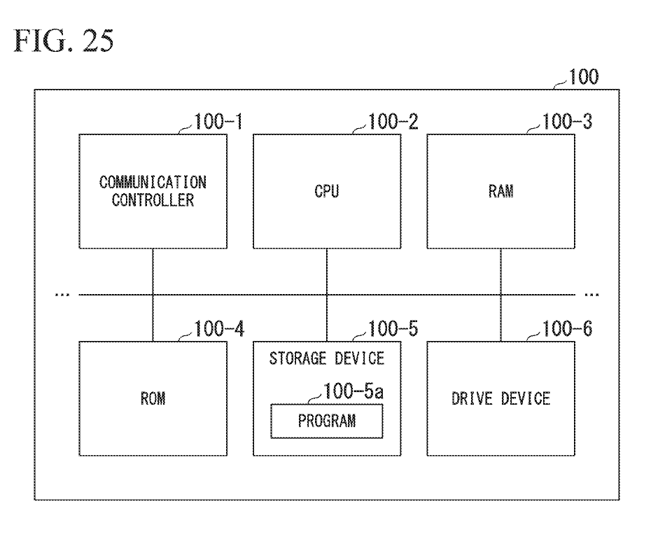

FIG. 25 is a diagram showing an example of the hardware configuration of the automated driving control device 100 according to an embodiment. As shown, the automated driving control device 100 is configured such that a communication controller 100-1, a CPU 100-2, a RAM 100-3 used as a working memory, a ROM 100-4 storing a boot program or the like, a storage device 100-5 such as a flash memory or an HDD, a drive device 100-6, or the like are connected to each other via an internal bus or a dedicated communication line. The communication controller 100-1 performs communication with components other than the automated driving control device 100. The storage device 100-5 stores a program 100-5a to be executed by the CPU 100-2. This program is loaded in the RAM 100-3 by a direct memory access (DMA) controller (not shown) or the like and then executed by the CPU 100-2. Thereby, some or all of the first controller 120, the second controller 160, and the third controller 170 are realized.

The embodiments described above can be expressed as follows.

A vehicle control device, including:

a display configured to display an image;

a storage configured to store a program; and

a processor,

wherein the processor is configured to execute the program to:

recognize an object present near the own vehicle, the object including another vehicle;

generate a target trajectory of the own vehicle on the basis of a state of the recognized object;

control at least one of a speed or steering of the own vehicle on the basis of the generated target trajectory; and

cause the display to display a first image simulating the other vehicle recognized as the object, a second image simulating the generated target trajectory, and a third image simulating a road in which the own vehicle is present such that the first and second images are superimposed on the third image,

wherein the second image is an image in which a first section that is on a near side of a reference vehicle, which is referred to when the target trajectory is generated, as viewed from the own vehicle among a plurality of sections into which the target trajectory is divided in a longitudinal direction is displayed with emphasis relative to a second section that is on a far side of the reference vehicle as viewed from the own vehicle.

Although the modes for carrying out the present invention have been described above by way of embodiments, the present invention is not limited to these embodiments at all and various modifications and substitutions can be made without departing from the gist of the present invention.

What is claimed is:

1. A vehicle control device, comprising:
a display configured to display an image;
a recognizer configured to recognize an object present near an own vehicle, the object including another vehicle;
a driving controller configured to generate a target trajectory of the own vehicle on the basis of a state of the object recognized by the recognizer and to control at least one of a speed or steering of the own vehicle on the basis of the generated target trajectory; and
a display controller configured to cause the display to display a first image simulating the other vehicle recognized as the object by the recognizer, a second image simulating the target trajectory generated by the driving controller, and a third image simulating a road in which the own vehicle is present such that the first and second images are superimposed on the third image,
wherein the second image is an image in which a first section that is on a near side of a reference vehicle, which is referred to when the target trajectory is generated, as viewed from the own vehicle among a plurality of sections into which the target trajectory is divided in a longitudinal direction is displayed with emphasis relative to a second section that is on a far side of the reference vehicle as viewed from the own vehicle.

2. The vehicle control device according to claim 1, wherein the second image is an image in which a portion corresponding to the first section is displayed and a portion corresponding to the second section is not displayed.

3. The vehicle control device according to claim 1, wherein the display controller is configured to change a display position of an end of the first section that is adjacent to the reference vehicle according to a position of the reference vehicle in an extension direction of a road.

4. The vehicle control device according to claim 1, wherein the display controller is configured to set another vehicle present in a lane adjacent to an own lane in which the own vehicle is present as the reference vehicle if, on the basis of the other vehicle present in the adjacent lane, the driving controller generates a target trajectory causing the own vehicle to change lanes from the own lane into a space either in front of or behind the other vehicle present in the adjacent lane.

5. A vehicle control method for an in-vehicle computer mounted in an own vehicle including a display configured to display an image, the method comprising:
the in-vehicle computer recognizing an object present near the own vehicle, the object including another vehicle;
generating a target trajectory of the own vehicle on the basis of a state of the recognized object;
controlling at least one of a speed or steering of the own vehicle on the basis of the generated target trajectory; and
causing the display to display a first image simulating the other vehicle recognized as the object, a second image simulating the generated target trajectory, and a third image simulating a road in which the own vehicle is present such that the first and second images are superimposed on the third image,
wherein the second image is an image in which a first section that is on a near side of a reference vehicle, which is referred to when the target trajectory is generated, as viewed from the own vehicle among a plurality of sections into which the target trajectory is divided in a longitudinal direction is displayed with emphasis relative to a second section that is on a far side of the reference vehicle as viewed from the own vehicle.

6. A computer-readable non-transitory storage medium storing a program causing an in-vehicle computer mounted in an own vehicle including a display configured to display an image to execute:
a process of recognizing an object present near the own vehicle, the object including another vehicle;
a process of generating a target trajectory of the own vehicle on the basis of a state of the recognized object;
a process of controlling at least one of a speed or steering of the own vehicle on the basis of the generated target trajectory;
a process of causing the display to display a first image simulating the other vehicle recognized as the object, a second image simulating the generated target trajectory, and a third image simulating a road in which the own vehicle is present such that the first and second images are superimposed on the third image; and
a process of causing the display to display, as the second image, an image in which a first section that is on a near side of a reference vehicle, which is referred to when the target trajectory is generated, as viewed from the own vehicle among a plurality of sections into which the target trajectory is divided in a longitudinal direction is displayed with emphasis relative to a second section that is on a far side of the reference vehicle as viewed from the own vehicle.
